(19) United States
(12) Patent Application Publication
(10) Pub. No.: US 2011/0212364 A1
(43) Pub. Date: Sep. 1, 2011

(54) POSITIVE ELECTRODE FOR NON-AQUEOUS ELECTROLYTE SECONDARY BATTERY AND METHOD OF MANUFACTURING THE SAME, AND NON-AQUEOUS ELECTROLYTE SECONDARY BATTERY USING THE POSITIVE ELECTRODE AND METHOD OF MANUFACTURING THE SAME

(75) Inventors: Takanobu Chiga, Kobe-shi (JP); Daisuke Katou, Kobe-shi (JP); Naoki Imachi, Kobe-shi (JP)

(73) Assignee: SANYO ELECTRIC CO., LTD., Osaka (JP)

(21) Appl. No.: 13/036,808

(22) Filed: Feb. 28, 2011

(30) Foreign Application Priority Data
Mar. 1, 2010 (JP) 2010-044019
Dec. 10, 2010 (JP) 2010-283362

(51) Int. Cl. H01M 4/131; H01M 4/1391; H01M 10/04; H01M 4/62; B05D 5/12

(52) U.S. Cl. 429/217; 429/218.1; 429/231.6; 429/231.9; 29/623.2; 429/231.95; 427/126.3

(57) ABSTRACT

A positive electrode for a non-aqueous electrolyte secondary battery, having a positive electrode current collector and a positive electrode active material layer formed on the positive electrode current collector and containing LiCoO₂ as an active material, PVDF as a binder agent, acetylene black as a conductive agent, and LiCF₃SO₃.

### BACKGROUND OF THE INVENTION

1. Field of the Invention

The present invention relates to improvements in non-aqueous electrolyte secondary batteries. More particularly, the invention relates to a battery structure that achieves an improvement in the flexibility of the positive electrode and makes it possible to obtain high reliability and high productivity even with a high capacity battery configuration.

2. Description of Related Art

Rapid advancements in size and weight reductions of mobile information terminal devices such as mobile telephones, notebook computers, and PDAs in recent years have created demands for higher capacity batteries as the drive power source for such devices. A non-aqueous electrolyte secondary battery has drawn attention as a high energy density battery that can meet such demands. The non-aqueous electrolyte secondary battery contains a negative electrode active material composed of an alloy or a carbon that is capable of intercalating and deintercalating lithium ions, and a positive electrode active material composed of a lithium-transition metal composite oxide.

Conventionally, the research and development efforts to increase the capacity of the non-aqueous electrolyte secondary batteries have centered around reducing the thicknesses of the components that do not relate to the capacity, such as battery can, separator, and current collector (aluminum foil or copper foil), as well as increasing of the filling density of active material (improvements in electrode filling density). However, when the electrode filling density is increased, the flexibility of the electrode decreases instead, so the electrode tends to cause fractures easily even with a small stress. This results in poor productivity of the battery. In addition, in order to obtain higher capacity and lower costs by reducing the volume of the separator and the current collector, which do not relate to capacity, it is necessary to coat the electrode with a thick electrode material. However, when the electrode is coated with a thick electrode material and calendered, the resulting electrode plate becomes very hard and lacks flexibility, so problems arise that the positive electrode may break when winding the electrode assembly. As a consequence, the productivity of the battery decreases considerably.

In order to resolve the just-described problem, it has been proposed to use two kinds of positive electrode active materials having different average particle sizes (see Japanese Published Unexamined Patent Application Nos. 2006-185887 and 2008-235157). However, when the positive electrode contains positive electrode active materials having different particle sizes, the charge-discharge reactions do not take place uniformly because their reactivities are different. Consequently, the battery performance such as the cycle performance may deteriorate.

In the present invention, a specific lithium salt is contained in the active material layer of the positive electrode, as will be described later. Japanese Published Unexamined Patent Application No. H05-62690 discloses that by adding such a lithium salt to the electrolyte solution, the storage performance or the cycle performance can be improved. However, this publication does not disclose addition of the lithium salt to the positive electrode active material layer or the resulting improvement in the flexibility of the positive electrode.

### BRIEF SUMMARY OF THE INVENTION

It is an object of the present invention to provide a positive electrode for a non-aqueous electrolyte secondary battery and a method of manufacturing the positive electrode that can improve the flexibility of the positive electrode active material layer without degrading the adhesion performance between the positive electrode current collector and the positive electrode active material layer and can thereby enhance reliability and productivity. It is also an object of the present invention to provide a non-aqueous electrolyte secondary battery using the positive electrode and a method of manufacturing the battery.

In order to accomplish the foregoing and other objects, the present invention provides a positive electrode for a non-aqueous electrolyte secondary battery, comprising: a positive electrode current collector; and a positive electrode active material layer formed on a surface of the positive electrode current collector, the positive electrode active material layer comprising a positive electrode active material, a binder agent, and a compound represented by the following general formula (1):

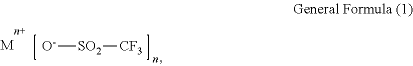

where n is an integer from 1 to 4 and M is a metallic element.

The present invention makes it possible to improve the flexibility of the positive electrode active material layer without degrading the adhesion performance between the positive electrode current collector and the positive electrode active material layer and can thereby enhance reliability and productivity even with a battery configuration that features a thick positive electrode active material layer and a high capacity.

### BRIEF DESCRIPTION OF THE DRAWINGS

FIG. 1 is a graph showing the relationship between the load and the displacement when a pressure is applied to a positive electrode; FIG. 2 is a schematic cross-sectional view for illustrating a test for evaluating the flexibility of the positive electrode;

FIG. 3 is a schematic cross-sectional view for illustrating a test for evaluating the flexibility of the positive electrode;

FIG. 4 is a graph for illustrating the relationship between the amounts of lithium salt added and the electrode plate hardness in invention positive electrodes a1 to a3 and comparative positive electrodes z1 to z4;

FIG. 5 is a graph for illustrating the relationship between the amounts of lithium salt added and the adhesion performance in the invention positive electrodes a1 to a3 and the comparative positive electrodes z1 to z4;

FIG. 6 is a SEM photograph of a coating film b; and

FIG. 7 is a SEM photograph of a coating film y.

### DETAILED DESCRIPTION OF THE INVENTION

As described above, the positive electrode for a non-aqueous electrolyte secondary battery according to the present invention comprises: a positive electrode current collector; and a positive electrode active material layer formed on a surface of the positive electrode current collector, the positive electrode active material layer comprising a positive electrode active material, a binder agent, and a compound represented by the following general formula (1):

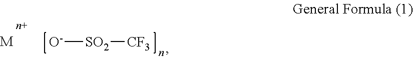

where n is an integer from 1 to 4 and M is a metallic element.

When the positive electrode active material layer contains the electrolyte containing CF₃SO₃⁻ as an anion as described above, the positive electrode has abundant flexibility. As a result, such a problem of breakage of the positive electrode in winding the electrode assembly can be avoided, and the reliability and productivity of the non-aqueous electrolyte secondary battery using the positive electrode can be enhanced. Although the details are not yet clear, the reason is believed to be as follows. The just-mentioned anion has CF₃, which is an electron-attracting substituent, so the minus charge does not easily localize. Therefore, the degree of dissociation of the cation becomes high. As a result, the electrolyte and the PVDF interact with each other in the positive electrode slurry, and the compound represented by the general formula (1) inhibits the growth of the particle of the binder agent. This causes the PVDF to be precipitated out in a very small size during the drying process. Thus, the number of the gap spaces in the positive electrode increases, resulting in an increase in the flexibility of the electrode plate. Because of the just-described reason, the type of cation is not limited in order to accomplish the objective of enhancing the flexibility of the positive electrode.

The above-described electrolyte does not inhibit the growth of the particle of the binder agent excessively, so the adhesion performance between the positive electrode active material layer and the positive electrode current collector does not degrade. It is desirable that M (cation) in the general formula (1) be at least one metallic element selected from the group consisting of group 1A elements, group 2A elements, group 4A elements, group 3B elements, and rare earth elements.

Examples of the group 1A elements include Li, Na, and K. Examples of the group 2A elements include Mg, Ca, and Sr. Examples of the group 4A elements include Ti, Zr, and Hf. Examples of the group 3B elements include Al, Ga, and In. Examples of the rare earth elements include Sc, Y, and La. These cations have stable valence states. Therefore, side reactions in the battery can be prevented.

It is desirable that M in the general formula (1) be at least one metallic element selected from the group consisting of lithium, sodium, magnesium, and lanthanum.

The electrolytes containing these cations and CF₃SO₃⁻ as anions can be available at low cost.

It is desirable that M in the general formula (1) be lithium.

When M is lithium, the electrolyte can contribute to charge-discharge reactions after it dissolves in the electrolyte solution.

It is desirable that the binder agent be a fluororesin having a vinylidene fluoride unit.

Although the fluororesin having a vinylidene fluoride unit shows excellent binding performance, it lacks flexibility when used as a binder agent because it has high crystallinity. Nevertheless, when the compound represented by the general formula (1) is contained, the positive electrode becomes flexible since the growth of the particle of the fluororesin having a vinylidene fluoride unit is hindered. Examples of the fluororesin having a vinylidene fluoride unit include PVDF and modified substances of PVDF.

It is desirable that the amount of the compound represented by the general formula (1) be from 0.01 mass % to 5.0 mass %, more desirably from 0.02 mass % to 2.0 mass %, with respect to the amount of the positive electrode active material.

If the amount of the compound represented by the general formula (1) is too small, the advantageous effects obtained by adding the compound cannot be fully exhibited, and the positive electrode may not become flexible. For this reason, it is preferable that the amount of the compound be 0.01 mass % or greater, more preferably 0.02 mass % or greater.

On the other hand, if the amount of the compound exceeds 5.0 mass %, it becomes difficult to obtain a high capacity battery because the relative amount of the positive electrode must be lowered correspondingly, although the advantageous effect of making the positive electrode flexible may be obtained sufficiently. In the present invention, it is more preferable that the amount of the compound be 2.0 mass % or less. The reason is that, if the amount of the compound is set at greater than 2.0 mass %, the growth of the particle of the binder agent may be inhibited excessively, and consequently, the adhesion performance between the positive electrode active material layer and the positive electrode current collector may be degraded.

Taking the foregoing into consideration, it is particularly desirable that the amount of the compound be from 0.02 mass % to 2.0 mass % with respect to the amount of the positive electrode active material.

In order to accomplish the foregoing and other objects, the present invention also provides a non-aqueous electrolyte secondary battery comprising any one of the foregoing positive electrodes, a negative electrode, and a non-aqueous electrolyte.

The non-aqueous electrolyte secondary battery having the just-described configuration makes it possible to obtain the above-described advantageous effects and in addition improve the discharge rate performance. The reason is as follows. Before filling the electrolyte solution in the battery case, the compound represented by the general formula (1) exists in the positive electrode active material layer, but after filling the electrolyte solution in the battery case, the compound dissolves in the electrolyte solution. When the compound dissolves in the electrolyte solution, the portions in which the compound has existed turn into gap spaces, and the electrolyte solution enters the gap spaces. As a result, the amount of the electrolyte solution within the positive electrode increases, improving the uniformity of the reactions in the positive electrode.

The invention also provides a method of manufacturing a positive electrode for a non-aqueous electrolyte secondary battery, comprising kneading a mixture containing a positive electrode active material, a binder agent, a compound represented by the following general formula (1):

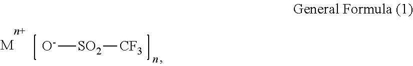

where n is an integer from 1 to 4 and M is a metallic element, to prepare a positive electrode active material slurry; and
coating the positive electrode active material slurry onto a surface of a positive electrode current collector to form a positive electrode active material layer on the surface of the positive electrode current collector.

The just-described method enables the manufacture of the above-described positive electrode.

A preferable example of the solvent used for preparing the positive electrode active material slurry is a commonly used N-methyl-2-pyrrolidone (NMP). It is preferable that the compound represented by the general formula (1) be used in an environment in which the moisture is controlled because the compound has high hygroscopicity.

It is desirable that M in the foregoing general formula (1) be at least one metallic element selected from the group consisting of group 1A elements, group 2A elements, group 4A elements, group 3B elements, and rare earth elements, more desirably at least one metallic element selected from the group consisting of lithium, sodium, magnesium, and lanthanum, and still more desirably lithium.

The reason why lithium is especially preferable is as follows. When M is lithium, the compound represented by the general formula (1) is LiCF₃SO₃. The LiCF₃SO₃ dissolves in the electrolyte solution after the electrolyte solution is filled in the battery case. Therefore, the LiCF₃SO₃ serves as a solute in the electrolyte solution, so it can contribute to the charge-discharge reactions along with the lithium salt that has been contained in the electrolyte solution in advance. As a result, the battery performance can be improved.

It is desirable that the binder agent be a fluororesin having a vinylidene fluoride unit.

It is desirable that in the step of preparing the positive electrode active material slurry, the amount of the compound represented by the general formula (1) be from 0.01 mass % to 5.0 mass %, more desirably from 0.02 mass % to 2.0 mass %, with respect to the amount of the positive electrode active material.

The present invention also provides a method of manufacturing a non-aqueous electrolyte secondary battery, comprising the steps of: preparing an electrode assembly using a positive electrode manufactured by the above-described method, a negative electrode, and a separator disposed between the positive and negative electrodes; and enclosing the electrode assembly and a non-aqueous electrolyte into a battery case.

The just-described method enables the manufacture of the above-described battery.

### Other Embodiments

(1) The positive electrode active material used in the present invention is not particularly restricted as long as it is capable of intercalating and deintercalating lithium and its potential is noble. Usable examples include lithium-transition metal composite oxides that have a layered structure, a spinel structure, or an olivine structure. In particular, the lithium-transition metal composite oxide having a layered structure is preferable from the viewpoint of achieving high energy density. Examples of the lithium-transition metal composite oxides include lithium-nickel composite oxides, lithium-nickel-cobalt composite oxides, lithium-nickel-cobalt-aluminum composite oxides, lithium-nickel-cobalt-manganese composite oxides, and lithium-cobalt composite oxides.

Particularly, a lithium-cobalt oxide in which Al or Mg is contained in the crystal in the form of solid solution and Zr is adhered to the particle surface is preferable from the view point of stability in the crystal structure.

From the viewpoint of reducing the amount of costly cobalt used, it is preferable to use a lithium-transition metal composite oxide in which the amount of nickel be 50 mole % or greater in the total amount of the transition metals contained in the positive electrode active material. In particular, from the viewpoint of stability of the crystal structure, it is preferable to use a lithium-transition metal composite oxide containing lithium, nickel, cobalt, and aluminum.

(2) The negative electrode active material used in the present invention may be any material as long as the material is capable of intercalating and deintercalating lithium. Examples of the negative electrode active material include carbon materials such as graphite and coke, metal oxides such as tin oxide, metals such as silicon and tin that can absorb lithium by alloying with lithium, and metallic lithium. Among them, graphite-based carbon materials are especially preferable since they show small volumetric changes associated with lithium intercalation and deintercalation and exhibit excellent reversibility.

(3) The solvent to be used in the present invention may be any solvent that has conventionally been used as a solvent for non-aqueous electrolyte secondary batteries. Particularly preferable example is a mixed solvent of a cyclic carbonate and a chain carbonate. In this case, it is preferable that the mixing ratio of the cyclic carbonate and the chain carbonate (cyclic carbonate:chain carbonate) be within the range of 1:9 to 5:5. Examples of the cyclic carbonate include ethylene carbonate, fluoroethylene carbonate, propylene carbonate, butylene carbonate, vinylene carbonate, and vinyl ethylene carbonate. Examples of the chain carbonate include dimethyl carbonate, methyl ethyl carbonate, and diethyl carbonate.

Examples of the solute used in the present invention include LiPF₆, LiBF₄, LiCF₃SO₃, LiN(SO₂CF₃)₂, LiN(SO₂C₂F₅)₂, LiC(SO₂CF₃)₃, LiC(SO₂C₂F₅)₃, LiClO₄, and mixtures thereof.

It is also possible to use, as the electrolyte, a gelled polymer electrolyte in which an electrolyte solution is impregnated in a polymer such as polyethylene oxide and polyacrylonitrile.

### DESCRIPTION OF PREFERRED EMBODIMENTS

Hereinbelow, examples of the non-aqueous electrolyte secondary battery according to the present invention are described in detail. It should be construed, however, that the non-aqueous electrolyte secondary battery according to this invention is not limited to the following embodiments and examples but various changes and modifications may be made without departing from the scope of the invention.

### Preparation of Positive Electrode

First, a positive electrode active material LiCoO₂ (containing 1.0 mol % of Al and 1.0 mol % of Mg in the form of solid solution, and having 0.05 mol % of Zr adhering to the surface), a conductive agent AB (acetylene black), a binder agent PVDF (polyvinylidene fluoride) were kneaded together with a NMP (N-methyl-pyrrolidone) solvent. Thereafter, to the mixture, an NMP solution in which a lithium salt LiCF₃SO₃ was dissolved was further added and agitated, to prepare a positive electrode active material slurry. In the positive electrode active material slurry, the mass ratio of LiCoO₂, AB, PVDF, and LiCF₃SO₃ was 94:2.5:2.5:1. Therefore, the amount of LiCF₃SO₃ was 1.1 mass % with respect to the amount of the positive electrode active material. Next, the positive electrode active material slurry was applied onto both sides of a positive electrode current collector made of an aluminum foil. The resultant article was then dried and calendered, whereby a positive electrode was prepared. The filling density of the positive electrode was set at 3.8 g/cc.

### Preparation of Negative Electrode

Graphite as a negative electrode active material, SBR (styrene-butadiene rubber) as a binder agent, and CMC (carboxymethylcellulose) as a thickening agent were kneaded in an aqueous solution, to prepare a negative electrode slurry. At that time, the ratio of graphite, SBR, and CMC was controlled to be 98:1:1. Next, the just-described negative electrode active material slurry was applied onto both sides of a negative electrode current collector made of a copper foil. The resultant article was then dried and calendered, whereby a negative electrode was prepared.

### Preparation of Non-aqueous Electrolyte Solution

LiPF₆ was dissolved at a concentration of 1 mol/L into a mixed solvent of 3:7 volume ratio of ethylene carbonate (EC) and diethyl carbonate (DEC), whereby a non-aqueous electrolyte solution was prepared.

### Construction of Battery

First, respective lead terminals were attached to the positive electrode and the negative electrode prepared in the above-described manner, and they were spirally wound with separators interposed therebetween. These were pressed into a flat shape to prepare an electrode assembly. Next, the electrode assembly was inserted into an aluminum laminate battery case, and thereafter, the non-aqueous electrolyte solution was filled therein, whereby a test battery was prepared. This battery had a design capacity of 750 mAh when charged to 4.4 V.

### EXAMPLES

### Example 1

A positive electrode and a battery of Example 1 were fabricated in the same manner as described in the just-described embodiment. The positive electrode and the battery prepared in this manner are hereinafter referred to as a positive electrode al of the invention and a Battery Al of the invention, respectively.

### Example 2

A positive electrode and a battery were prepared in the same manner as described in Example 1 above, except that when preparing the positive electrode active material slurry, the mass ratio of LiCoO₂, AB, PVDF, and LiCF₃SO₃ was set at 94.5:2.5:2.5:0.5 (i.e., the amount of LiCF₃SO₃ was set at 0.5 mass % with respect to the amount of the positive electrode active material).

The positive electrode and the battery prepared in this manner are hereinafter referred to as a positive electrode a2 of the invention and a Battery A2 of the invention, respectively.

### Example 3

A positive electrode and a battery were prepared in the same manner as described in Example 1 above, except that when preparing the positive electrode active material slurry, the mass ratio of LiCoO₂, AB, PVDF, and LiCF₃SO₃ was set at 94.9:2.5:2.5:0.1 (i.e., the amount of LiCF₃SO₃ was set at 0.1 mass % with respect to the amount of the positive electrode active material).

The positive electrode and the battery prepared in this manner are hereinafter referred to as a positive electrode a3 of the invention and a Battery A3 of the invention, respectively.

### Example 4

A positive electrode and a battery were prepared in the same manner as described in Example 3 above, except that when preparing the positive electrode active material slurry, NaCF₃SO₃ was used in place of LiCF₃SO₃. The positive electrode and the battery prepared in this manner are hereinafter referred to as a positive electrode a4 of the invention and a Battery A4 of the invention, respectively.

### Example 5

A positive electrode and a battery were prepared in the same manner as described in Example 3 above, except that when preparing the positive electrode active material slurry, Mg(CF₃SO₃)₂ was used in place of LiCF₃SO₃.

The positive electrode and the battery prepared in this manner are hereinafter referred to as a positive electrode a5 of the invention and a Battery AS of the invention, respectively.

### Example 6

A positive electrode and a battery were prepared in the same manner as described in Example 3 above, except that when preparing the positive electrode active material slurry, La(CF₃SO₃)₃ was used in place of LiCF₃SO₃.

The positive electrode and the battery prepared in this manner are hereinafter referred to as a positive electrode a6 of the invention and a Battery A6 of the invention, respectively.

### Comparative Example 1

A positive electrode and a battery were prepared in the same manner as described in Example 1 above, except that when preparing the positive electrode active material slurry, LiN(SO₂CF₃)₂ was used as the lithium salt in place of LiCF₃SO₃.

The positive electrode and the battery prepared in this manner are hereinafter referred to as a comparative positive electrode z1 and a Comparative Battery Z1, respectively.

### Comparative Example 2

A positive electrode and a battery were prepared in the same manner as described in Example 2 above, except that when preparing the positive electrode active material slurry, LiN(SO₂CF₃)₂ was used as the lithium salt in place of LiCF₃SO₃.

The positive electrode and the battery prepared in this manner are hereinafter referred to as a comparative positive electrode z2 and a Comparative Battery Z2, respectively.

### Comparative Example 3

A positive electrode and a battery were prepared in the same manner as described in Example 3 above, except that when preparing the positive electrode active material slurry, LiN(SO₂CF₃)₂ was used as the lithium salt in place of LiCF₃SO₃.

The positive electrode and the battery prepared in this manner are hereinafter referred to as a comparative positive electrode z3 and a Comparative Battery Z3, respectively.

### Comparative Example 4

A positive electrode and a battery were prepared in the same manner as described in Example 1 above, except that when preparing the positive electrode active material slurry, no LiCF₃SO₃ was added as the lithium salt. The mass ratio of LiCoO₂, AB, and PVDF was set at 95:2.5:2.5.

The positive electrode and the battery prepared in this manner are hereinafter referred to as a comparative positive electrode z4 and a Comparative Battery Z4, respectively.

### Comparative Example 5

A positive electrode and a battery were prepared in the same manner as described in Comparative Example 4 above, except that in addition to adding LiPF₆ at a concentration of 1 mol/L, LiCF₃SO₃ was added at a concentration of 0.15 mol/L to a mixed solvent of 3:7 volume ratio of EC and DEC. The total amount of LiCF₃SO₃ in the battery was set at the same amount thereof in the foregoing Battery A1 of the invention.

The positive electrode and the battery prepared in this manner are hereinafter referred to as a comparative positive electrode z5 and a Comparative Battery Z5, respectively.

### Experiment 1

In Experiment 1, the flexibility of the electrode plates and the adhesion performance thereof were determined using the above-described positive electrodes a1 through a6 and the comparative positive electrodes z1 through z4.

### Evaluation Method for Flexibility

The flexibility of each of the positive electrodes a1 through a6 of the invention as well as the comparative positive electrodes z1 through z4 was determined in the following manner. First, a positive electrode was cut out into a size of width 50 mm×length 20 mm, and as illustrated in FIG. 2, both ends of the cut-out positive electrode 1 were bonded to an end of an acrylic plate 2 having a width of 30 mm using a double-sided tape.

Next, using a force gauge (FGS-TV and FGP-0.5 made by Nidec-Shimpo Corp.), a central portion 1a of the positive electrode 1 was pressed with a pressing force 3. The speed of the pressing was a constant speed of 20 mm/min.

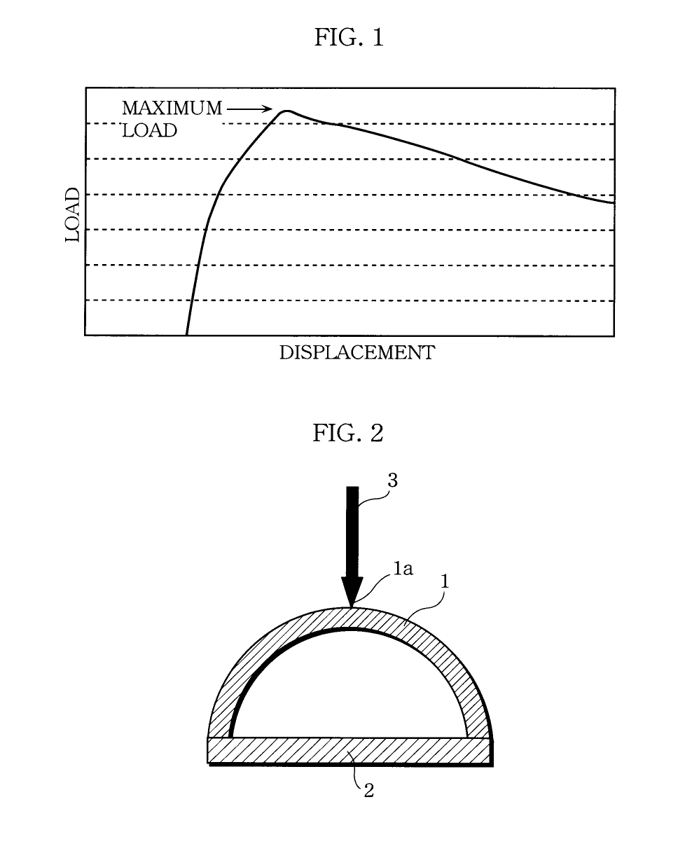

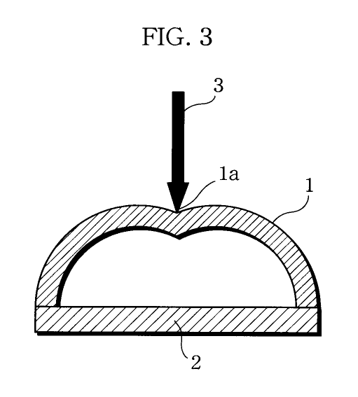

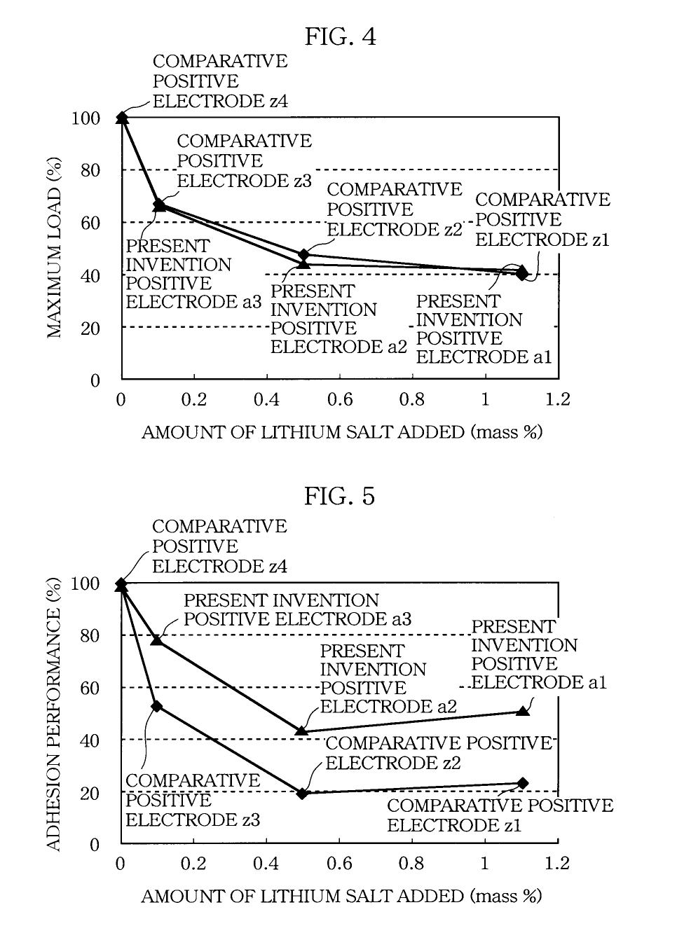

FIG. 3 is a schematic cross-sectional view illustrating the positive electrode 1 in which a dent is formed by a pressing force 3 at its central portion 1a. The load obtained immediately before such a dent was formed was defined as the maximum value of the load. FIG. 1 is a graph illustrating the relationship between the load applied to the positive electrode and the displacement. As illustrated in FIG. 1, the maximum value of the load was obtained as the maximum load. The maximum loads obtained for the respective positive electrodes are shown in Table 1 and FIG. 4, as the values indicating the flexibility of each of the positive electrodes. In Table 1 and FIG. 4, the values of the maximum load are index numbers relative to the maximum load for the comparative positive electrode z4, which is taken as 100. The smaller the maximum load value is, the greater the flexibility.

### Evaluation Method for Adhesion Performance

The adhesion performance of each of the positive electrodes a1 to a6 and the comparative positive electrodes z1 to z4 was determined by a 90-degree peeling test.

The details are as follows. Using a double-sided tape (Naistak NW-20 made by Nichiban Co., Ltd.) having dimensions of 70 mm×20 mm, each sample of the positive electrodes was affixed to an acrylic board having dimensions of 120 mm×30 mm, and one end of the affixed positive electrode was pulled using a small-sized portable test stand (FGS-TV and FGP-5 made by Nidec-Shimpo Corp.), to measure the strength at the time when the positive electrode active material layer was peeled off from the positive electrode current collector. The direction of the pulling was a 90-degree direction with respect to the positive electrode active material, the rate of the pulling was a constant rate (50 mm/min.), and the pulling distance was 55 mm. The strength obtained for the measured positive electrode at the time of peeling was defined as the adhesion performance. The results are shown in Table 1 and FIG. 5. In Table 1 and FIG. 5, the values are indicated by index numbers relative to the strength at the time of peeling for the comparative positive electrode z4, which is taken as 100.

### Experiment 2

In Experiment 2, the discharge capacity and the discharge rate ratio at 3.0 It (discharge rate performance) were determined for each of Batteries A1 to A6 of the invention and Comparative Batteries Z1 to Z5. Note that for Comparative Batteries Z1 to Z3, the rate ratio at 3.0 It were not measured.

### Evaluation Method for Discharge Capacity

Each of Batteries A1 to A6 of the invention and Comparative Batteries Z1 to Z5 was charged at a constant current of 1.0 It (750 mA) until the battery voltage reached 4.4 V and thereafter further charged at a constant voltage of 4.4 V until the current reached 1/20 It (37.5 mA). Then, each of the batteries was discharged at a constant current of 1.0 It (750 mA) until the battery voltage reached 2.75 V. Then, the discharge capacity of each of the batteries was measured. The results are shown in Table 1 below.

### Evaluation of Discharge Rate Performance

Each of Batteries A1 to A6 of the invention and Comparative Batteries Z4 and Z5 was charged at a constant current of 1.0 It (750 mA) until the battery voltage reached 4.4 V and thereafter further charged at a constant voltage of 4.4 V until the current reached 1/20 C (37.5 mA). Then, each of the batteries was discharged at a constant current of 1.0 It (750 mA) until the battery voltage reached 2.75 V, to thereby determine the discharge capacity at 1.0 It.

Next, each of the batteries was charged under the same conditions as the just-described conditions, and thereafter discharged at a constant current of 3.0 It (2250 mA) until the battery voltage reached 2.75 V, to thereby determine the discharge capacity at 3.0 It. Then, the discharge rate ratio (%) of each of the batteries was calculated using the following equation. The results are shown in Table 1 below.

Discharge rate ratio at 3.0 It (%)=(Discharge capacity at 3.0 It/Discharge capacity at 1.0 It)×100

TABLE 1

| | Part to | | | | | | Discharge |
|---|---|---|---|---|---|---|---|
| Battery | which the | | Amount | | Adhesion | Discharge | rate ratio |
| (Positive | electrolyte | Electrolyte | added | Maximum | performance | capacity | at 3.0 It |
| electrode) | is added | added | (mass %) | load (%) | (%) | (%) | (%) |
| A1 (a1) | Positive | LiCF₃SO₃ | 1.1 | 41 | 51 | 743 | 91 |
| A1 (a2) | electrode | | 0.5 | 44 | 43 | 753 | 89 |
| A3 (a3) | | | 0.1 | 66 | 78 | 748 | 88 |
| A4 (a4) | | NaCF₃SO₃ | 0.1 | 63 | 67 | 741 | 86 |
| A5 (a5) | | Mg(CF₃SO₃)₂ | 0.1 | 67 | 71 | 746 | 88 |
| A6 (a6) | | La(CF₃SO₃)₃ | 0.1 | 62 | 65 | 747 | 90 |
| Z1 (z1) | | LiN(SO₂CF₃)₂ | 1.1 | 40 | 23 | 747 | — |
| Z2 (z2) | | | 0.5 | 48 | 19 | 756 | — |
| Z3 (z3) | | | 0.1 | 67 | 53 | 748 | — |
| Z4 (z4) | Not added | — | — | 100 | 100 | 755 | 84 |
| Z5 (z5) | Electrolyte | LiCF₃SO₃ | 0.15 | 100 | — | 755 | 85 |
| | solution | | (mol/L) | | | | |

### Results of Evaluation for Flexibility

The positive electrodes a1 to a3 of the invention, in which LiCF₃SO₃ was added as the lithium salt, exhibited significantly lower maximum loads (electrode plate hardness) than the comparative positive electrode z4, in which the lithium salt was not added, indicating that the positive electrode flexibility was improved significantly. In addition, the positive electrodes a1 to a3 of the invention showed almost the same level of flexibility as the comparative positive electrodes z1 to z3, in which LiN(SO₂CF₃)₂ was add as the lithium salt, when each of the positive electrodes was compared to the comparative electrode with the same amount of the lithium salt added (for example, when the positive electrode a1 of the invention was compared to the comparative positive electrode z1, each of which had the same amount of the lithium salt added, 1.1 mass %).

Moreover, the positive electrodes a4 to a6 of the invention, which used NaCF₃SO₃, Mg(CF₃SO₃)₂, and La(CF₃SO₃)₃, respectively, as the electrolyte added to the positive electrode in place of LiCF₃SO₃, also exhibited significantly reduced maximum load (electrode plate hardness), indicating that the positive electrode flexibility was significantly improved. It is believed that these results were obtained for the following reason.

In the positive electrodes a1 to a6, CF₃SO₃⁻ is used as the electrolyte anion added to the positive electrode. This anion has an electron-attracting substituent, CF₃, so the minus charge does not easily localize. Therefore, the degree of dissociation of the cation becomes high. As a result, the electrolyte and the PVDF interact with each other in the positive electrode slurry, and LiCF₃SO₃ inhibits the growth of the particle of the binder agent. This causes the PVDF to be precipitated out in a very small size during the drying process. As a result, the number of the gap spaces in the positive electrode becomes greater than in the case in which the electrolyte such as LiCF₃SO₃ was not added, resulting in an increase in the flexibility of the electrode plate. In order to verify this, two types of the coating films prepared in the following manners were observed by a SEM.

### Preparation Method for Coating Film b

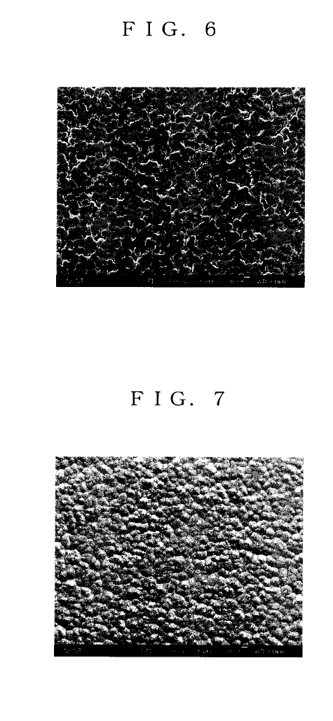

First, an NMP solution containing PVDF dissolved therein and an NMP solution containing LiCF₃SO₃ dissolved therein were mixed and stirred together. The mass ratio of PVDF and LiCF₃SO₃ in the solution was set at 100:20. Next, the stirred solution was applied onto the surface of an aluminum foil, whereby a coating film b was prepared. A SEM photograph of the resulting coating film b is shown in FIG. 6.

### Preparation Method for Coating Film y

A coating film y was prepared in the same manner as for the coating film b, except that LiCF₃SO₃ was not added (i.e., an NMP solution containing PVDF dissolved therein alone was applied onto the surface of an aluminum foil). A SEM photograph of the resulting coating film y is shown in FIG. 7.

FIG. 7 clearly shows that in the coating film y, which contained only PVDF, PVDF formed a dense film. On the other hand, FIG. 6 clearly shows that many gap spaces were formed in the coating film b, in which LiCF₃SO₃ was added to PVDF. Thus, because of the presence of LiCF₃SO₃, the precipitation state of PVDF changed (i.e., PVDF was precipitated out in a very small size), and as a result, the electrode plate became flexible.

### Results of Evaluation for Adhesion Performance

The positive electrodes a1 to a3 of the invention show lower adhesion performance than the comparative positive electrode z4. Nevertheless, it is clear that when they are compared to the comparative positive electrodes z1 to z3 with the same amount of the lithium salt added, they exhibit significantly improved adhesion performance over the comparative positive electrodes z1 to z3. The positive electrodes a4 to a6 containing different electrolytes (metal salts) from the positive electrodes a1 to a3 of the invention (but in the same amount as that in the positive electrode a3 of the invention) showed only slightly lower adhesion performance than the positive electrode a3 of the invention, and they exhibited significantly improved adhesion performance of the positive electrode over the comparative positive electrode z3, which contained a different electrolyte but in the same amount of electrolyte added.

### Results of Evaluation for Discharge Capacity

The results shown in Table 1 clearly demonstrate that the discharge capacities are almost the same and not much different among Batteries A1 to A3 of the invention and Comparative Batteries Z1 to Z4. In addition, Batteries A4 to A6 of the invention, in which the electrolytes added to the positive electrode were different from that in Batteries A1 to A3 of the invention, achieved almost the same level of discharge capacity obtained by Batteries A1 to A3 of the invention.

### Results of Evaluation for Discharge Rate Performance

As clearly seen from Table 1, Batteries A1 to A6 of the invention, each containing an added electrolyte, exhibited higher discharge rate ratios (improved discharge rate performance) than Comparative Battery Z4, in which no added electrolyte was contained.

When comparing Batteries A1 to A3 of the invention to each other, the greater the amount of the LiCF₃SO₃ added to the positive electrode, the better the discharge rate performance. This may appear to indicate that the discharge rate performance can be improved by simply increasing the amount of the lithium salt in the battery. For the following two reasons, it is believed that simply increasing the amount of the lithium salt in the battery does not directly lead to an improvement in discharge rate performance.

(1) When Battery A1 of the invention was compared to Comparative Battery Z5, Battery A1 of the invention exhibited better discharge rate performance than Comparative Battery Z5, although both Batteries A1 and Z5 had the same total amount of the lithium salt (LiCF₃SO₃) in each of the batteries.

(2) It was clearly demonstrated that even Batteries A4 to A6 of the invention, each containing an electrolyte that is not a lithium salt, exhibited improvements in discharge rate performance over Comparative Battery Z5, in which a lithium salt was added.

From the foregoing, it is clear that the improvement in the discharge rate performance was not simply due to the increase of the lithium salt concentration in the electrolyte solution.

Accordingly, it is believed that the improvements in discharge rate performance in Batteries A1 to A6 of the invention are due to the following reason. In Batteries A1 to A6 of the invention, the electrolyte contained in the positive electrode dissolves into the solvent of the electrolyte solution after the assembling of the battery, forming gap spaces in the positive electrode. As a result, diffusion of the electrolyte solution in the positive electrode takes place easily. On the other hand, in Comparative Battery Z5, such dissolution of the electrolyte does not occur, and consequently, diffusion of the electrolyte solution in the positive electrode becomes insufficient.

### Overall Evaluation

Considering the evaluation results of the flexibility, the adhesion performance, the discharge capacity, and the discharge rate performance comprehensively, it is concluded that addition of an electrolyte using CF₃SO₃ as an anion to the positive electrode active material layer enables the electrode plate to become flexible and as a result makes it possible to increase the productivity of the battery. Moreover, the added electrolyte dissolves into the electrolyte solution, forming gap spaces in the positive electrode, so diffusion of the electrolyte solution takes place more easily. As a result, high-rate performance can be improved.

When the electrolyte as described above is added to the positive electrode active material layer, the adhesion performance decreases slightly. However, the decrease is not to a problematic level, and moreover, the discharge capacity remains at the same level as that of the conventional battery.

The present invention is expected to be applicable to the power sources for mobile information terminals such as mobile telephones, notebook computers, and PDAs, as well as the power sources for the applications that require high power, such as HEVs and power tools.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A positive electrode for a non-aqueous electrolyte secondary battery, comprising: a positive electrode current collector; and a positive electrode active material layer formed on a surface of the positive electrode current collector, the positive electrode active material layer comprising a positive electrode active material, a binder agent, and a compound represented by the following general formula (1): 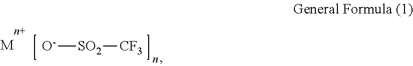
where n is an integer from 1 to 4 and M is a metallic element.

2. The positive electrode for a non-aqueous electrolyte secondary battery according to claim 1, wherein M in the general formula (1) is at least one metallic element selected from the group consisting of group 1A elements, group 2A elements, group 4A elements, group 3B elements, and rare earth elements.

3. The positive electrode for a non-aqueous electrolyte secondary battery according to claim 2, wherein M in the general formula (1) is at least one metallic element selected from the group consisting of lithium, sodium, magnesium, and lanthanum.

4. The positive electrode for a non-aqueous electrolyte battery according to claim 3, wherein M in the general formula (1) is lithium.

5. The positive electrode for a non-aqueous electrolyte battery according to claim 1, wherein the binder agent is a fluororesin having a vinylidene fluoride unit.

6. The positive electrode for a non-aqueous electrolyte battery according to claim 1, wherein the amount of the compound represented by the general formula (1) is from 0.01 mass % to 5.0 mass % with respect to the amount of the positive electrode active material.

7. The positive electrode for a non-aqueous electrolyte battery according to claim 6, wherein the amount of the compound represented by the general formula (1) is from 0.02 mass % to 2 mass % with respect to the amount of the positive electrode active material.

8. A non-aqueous electrolyte secondary battery comprising a positive electrode according to claim 1, a negative electrode, and a non-aqueous electrolyte.

9. A method of manufacturing a positive electrode for a non-aqueous electrolyte secondary battery, comprising the steps of:
kneading, in a solvent, a mixture containing a positive electrode active material, a binder agent, a compound represented by the following general formula (1): 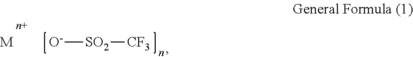
where n is an integer from 1 to 4 and M is a metallic element, to prepare a positive electrode active material slurry; and
coating the positive electrode active material slurry onto a surface of a positive electrode current collector to form a positive electrode active material layer on the surface of the positive electrode current collector.

10. The method according to claim 9, wherein M in the general formula (1) is at least one metallic element selected from the group consisting of group 1A elements, group 2A elements, group 4A elements, group 3B elements, and rare earth elements.

11. The method according to claim 10, wherein M in the general formula (1) is at least one metallic element selected from the group consisting of lithium, sodium, magnesium, and lanthanum.

12. The method according to claim 11, wherein M in the general formula (1) is lithium.

13. The method according to claim 9, wherein the binder agent is a fluororesin having a vinylidene fluoride unit.

14. The method according to claim 9, wherein, in the step of preparing the positive electrode active material slurry, the amount of the compound represented by the general formula (1) is from 0.01 mass % to 5.0 mass % with respect to the amount of the positive electrode active material.

15. The method according to claim 14, wherein the amount of the compound represented by the general formula (1) is from 0.02 mass % to 2 mass % with respect to the amount of the positive electrode active material.

16. A method of manufacturing a non-aqueous electrolyte secondary battery, comprising the steps of:
preparing an electrode assembly using a positive electrode manufactured by a method according to claim 9, a negative electrode, and a separator disposed between the positive and negative electrodes; and
enclosing the electrode assembly and a non-aqueous electrolyte into a battery case.
